(19) United States
(12) Patent Application Publication
(10) Pub. No.: US 2013/0055259 A1
(43) Pub. Date: Feb. 28, 2013

(54) METHOD AND APPARATUS FOR HANDLING AN I/O OPERATION IN A VIRTUALIZATION ENVIRONMENT

(71) Applicant: Yaozu Dong, Shanghai (CN)

(72) Inventor: Yaozu Dong, Shanghai (CN)

(21) Appl. No.: 13/576,932

(22) PCT Filed: Dec. 24, 2009
(86) PCT No.: PCT/CN2009/001543

§ 371 Date: Nov. 5, 2012

(51) Int. Cl. G06F 9/455

(52) U.S. Cl. 718/1

(57) ABSTRACT

Machine-readable media, methods, apparatus and system for. Method and apparatus for handling an I/O operation in a virtualization environment. In some embodiments, a system comprises a hardware machine comprising an input/output (I/O) device; and a virtual machine monitor to interface the hardware machine and a plurality of virtual machines. In some embodiments, the virtual machine comprises a guest virtual machine to write input/output (I/O) information related to an I/O operation and a service virtual machine comprising a device model and a device driver, wherein the device model invokes the device driver to control a part of the I/O device to implement the I/O operation with use of the I/O information, and wherein the device model, the device driver and the part of the I/O device are assigned to the guest virtual machine.

### BACKGROUND

Virtual machine architecture may logically partition a physical machine, such that the underlying hardware of the machine is shared and appears as one or more independently operating virtual machines. Input/output (I/O) virtualization (IOV) may realize a capability of an I/O device used by a plurality of virtual machines.

Software full device emulation may be one example of the I/O virtualization. Full emulation of the I/O device may enable the virtual machines to reuse existing device drivers. Single root I/O virtualization (SR-IOV) or any other resource partitioning solutions may be another example of the I/O virtualization. To partition I/O device function (e.g., the I/O device function related to data movement) into a plurality of virtual interface (VI), with each assigned to one virtual machine, may reduce I/O overhead in the software emulation layer.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a computing platform including a service virtual machine to control an I/O operation originated in a guest virtual machine.

FIG. 2a illustrates an embodiment of a descriptor ring structure storing I/O descriptors for the I/O operation.

FIG. 2b illustrates an embodiment of a descriptor ring structure and a shadow descriptor ring structure storing I/O descriptors for the I/O operation.

FIG. 3 illustrates an embodiment of an input/output memory management unit (IOMMU) table for direct memory access (DMA) by an I/O device.

FIG. 4 illustrates an embodiment of a method of writing I/O information related to the I/O operation by the guest virtual machine.

FIG. 5 illustrates an embodiment of a method of handling the I/O operation based upon the I/O information by the service virtual machine.

FIG. 6a-6b illustrates another embodiment of a method of handling the I/O operation based upon the I/O information by the service virtual machine.

### DETAILED DESCRIPTION OF THE PREFERRED EMBODIMENTS

The following description describes techniques for handling an I/O operation in a virtualization environment. In the following description, numerous specific details such as logic implementations, pseudo-code, means to specify operands, resource partitioning/sharing/duplication implementations, types and interrelationships of system components, and logic partitioning/integration choices are set forth in order to provide a more thorough understanding of the current invention. However, the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, that may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.) and others.

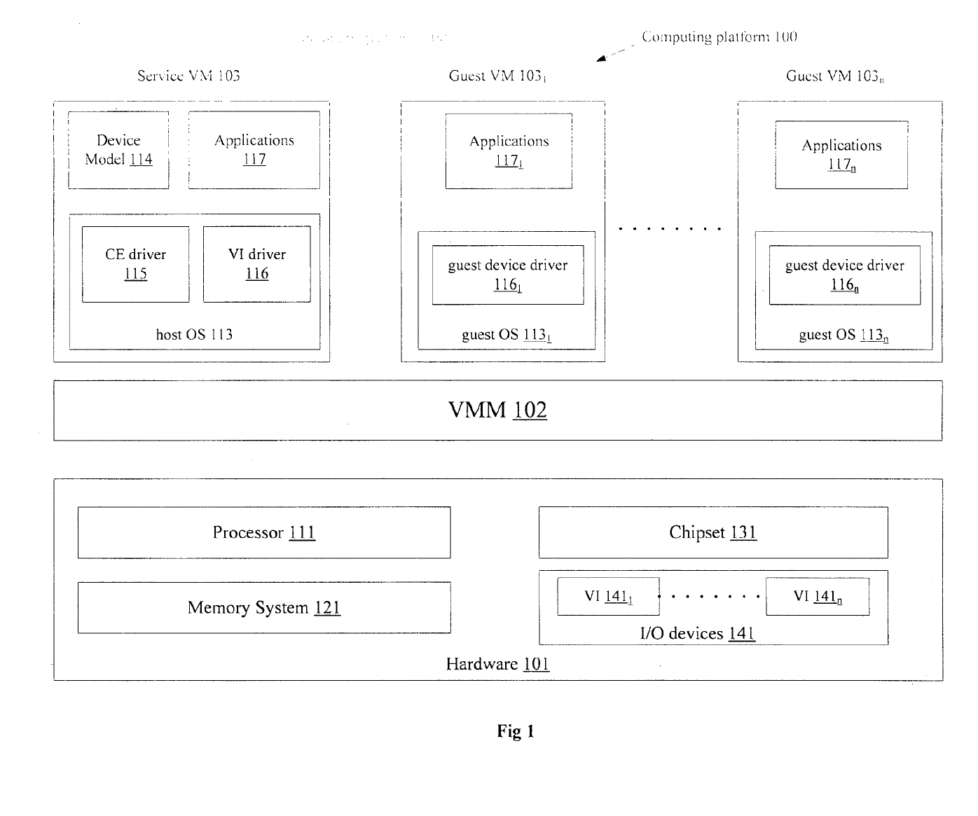

An embodiment of a computing platform 100 handling an I/O operation in a virtualization environment is shown in FIG. 1. A non-exhaustive list of examples for computing system 100 may include distributed computing systems, supercomputers, computing clusters, mainframe computers, mini-computers, personal computers, workstations, servers, portable computers, laptop computers and other devices for transceiving and processing data.

In the embodiment, computing platform 100 may comprise an underlying hardware machine 101 having one or more processors 111, memory system 121, chipset 131, I/O devices 141, and possibly other components. One or more processors 111 may be communicatively coupled to various components (e.g., the chipset 131) via one or more buses such as a processor bus (not shown in FIG. 1). Processors 111 may be implemented as an integrated circuit (IC) with one or more processing cores that may execute codes under a suitable architecture.

Memory system 121 may store instructions and data to be executed by the processor 111. Examples for memory 121 may comprise one or any combination of the following semiconductor devices, such as synchronous dynamic random access memory (SDRAM) devices, RAMBUS dynamic random access memory (RDRAM) devices, double data rate (DDR) memory devices, static random access memory (SRAM), and flash memory devices.

Chipset 131 may provide one or more communicative paths among one or more processors 111, memory 121 and other components, such as I/O device 141. I/O device 141 may comprise, but not limited to, peripheral component interconnect (PCI) and/or PCI express (PCIe) devices connecting with host motherboard via PCI or PCIe bus. Examples of I/O device 141 may comprise a universal serial bus (USB) controller, a graphics adapter, an audio controller, a network interface controller (NIC), a storage device, etc.

Computing platform 100 may further comprise a virtual machine monitor (VMM) 102, responsible for interfacing underlying hardware and overlying virtual machines (e.g., service virtual machine 103, guest virtual machine 103₁-103ₙ) to facilitate and manage multiple operating systems (OSes) of the virtual machines (e.g., host operating system 113 of service virtual machine 103, guest operating systems 113₁-113ₙof guest virtual machine 103₁-103ₙ) to share underlying physical resources. Examples of the virtual machine monitor may comprise Xen, ESX server, virtual PC, Virtual Server, Hyper-V, Parallel, OpenVZ, Qemu, etc.

In an embodiment, I/O device 141 (e.g., a network card) may be partitioned into several function parts, including a control entity (CE) 141₀ supporting an input/output virtualization (IOV) architecture (e.g., single-root IOV) and multiple virtual function interface (VI) 141₁-141ₙ having runtime resources for dedicated accesses (e.g., queue pairs in network device). Examples of the CE and VI may include physical function and virtual function under Single Root I/O Virtualization architecture or Multi-Root I/O Virtualization architecture. CE may further configure and manage VI functionalities. In an embodiment, multiple guest virtual machines 103₁-103ₙ may share physical resources controlled by CE 141₀, while each of guest virtual machines 103₁-103ₙ may be assigned with one or more of VIs 141₁-141ₙ. For example, guest virtual machine 103₁ may be assigned with VI 141₁.

It will be appreciated that other embodiments may implement other technologies for the structure of I/O device 141. In an embodiment, I/O device 141 may include one or more VIs without CE. For example, a legacy NIC without the partitioning capability may include a single VI working under a NULL CE condition.

Service virtual machine 103 may be loaded with codes of a device model 114, a CE driver 115 and a VI driver 116. Device model 114 may be or may not be software emulation of a real I/O device 141. CE driver 115 may manage CE 141₀ which is related to I/O device initialization and configuration during the initialization and runtime of computing platform 100. VI driver 116 may be a device driver to manage one or more of VI 141₁-VI 141 ₙ depending on a management policy. In an embodiment, based on the management policy, VI driver may manage resources allocated to a guest VM that the VI driver may support, while CE driver may manage global activities.

Each of guest virtual machine 103₁-103ₙ may be loaded with codes of a guest device driver managing a virtual device presented by VMM 102, e.g., guest device driver 116₁ of guest virtual machine 103₁ or guest device driver 116ₙ of guest virtual machine 103. Guest device driver may be able or unable to work in a mode compatible with VIs 141 and their drivers 116. In an embodiment, the guest device driver may be a legacy driver.

In an embodiment, in response that a guest operating system of a guest virtual machine (e.g., guest OS 113₁ of Guest VM 103₁) loads a guest device driver (e.g., guest device driver 116₁), service VM 103 may run an instance of device model 114 and VI driver 116. For example, the instance of device model 114 may serve guest device driver 116₁, while the instance of VI driver 116 may control VI 141₁ assigned to guest VM 103₁. For example, if guest device driver 116₁ is a legacy driver of 82571EB based NIC (a network controller manufactured by Intel Corporation, Santa Clara of Calif.) and VI 141₁ assigned to guest VM 103₁ is a 82571EB based NIC or other type of NIC compatible or incompatible with 82571EB based NIC, then service VM 103 may run an instance of device model 114 representing a virtual 82571EB based NIC and an instance of VI driver 116 controlling VI 141₁, i.e., the 82571EB based NIC or other type of NIC compatible or incompatible with the 82571EB based NIC.

It will be appreciated that embodiment as shown in FIG. 1 is provided for illustration, and other technologies may implement other embodiments of computing system 100. For example, device model 114 may be incorporated with VI driver 116, or CE driver, or all in one box etc. They may run in privilege mode such as OS kernel, or non privilege mode such as OS user land. Service VM may even be split into multiple VMs, with one VM running CE, while another VM running Device Model and VI driver or any other combinations with sufficient communications between the multiple VMs.

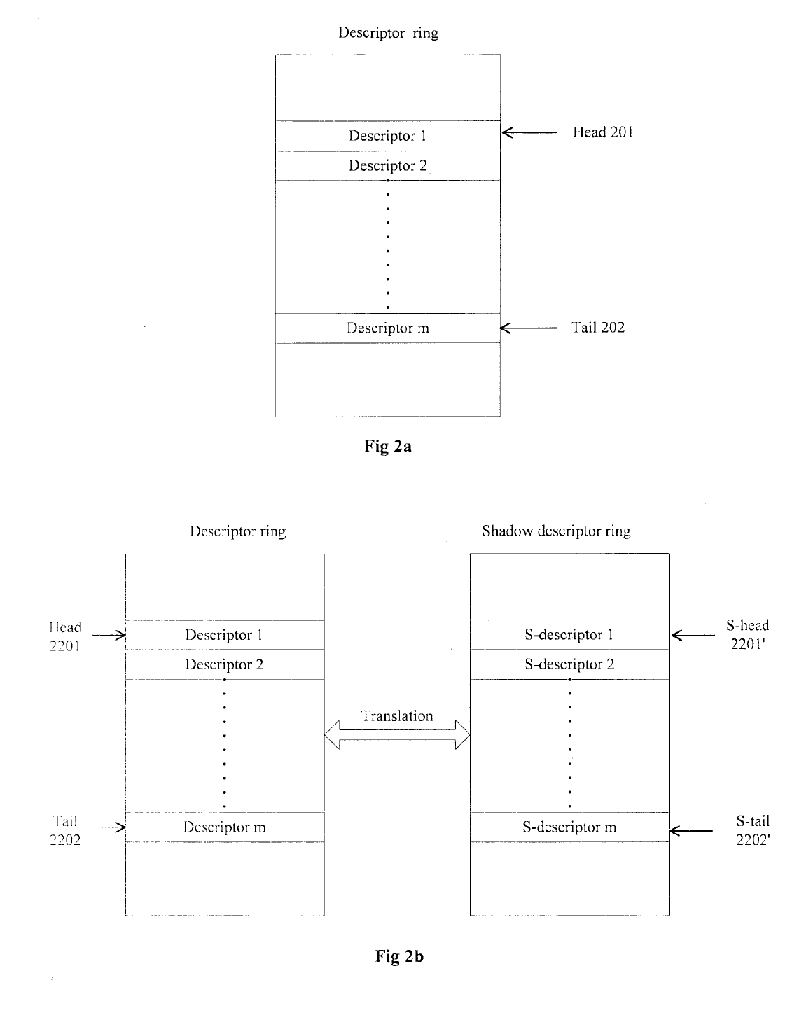

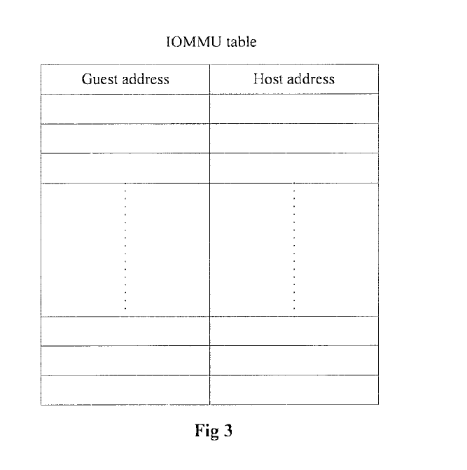

In an embodiment, if an I/O operation is instructed by an application (e.g., application 117₁) running on the guest VM 103₁, guest device driver 116₁ may write I/O information related to the I/O operation into a buffer (not shown in FIG. 1) assigned to the guest VM 103₁. For example, guest device driver 116₁ may write I/O descriptors into a ring structure as shown in FIG. 2a, with one entry of the ring structure for one I/O descriptor. In an embodiment, an I/O descriptor may indicate an I/O operation related to a data packet. For example, if guest application 117₁ instructs to read or write 100 packets from or to guest memory addresses xxx-yyy, guest device driver 116₁ may write 100 I/O descriptors into the descriptor ring of FIG. 2a. Guest device driver 116₁ may write the descriptors into the descriptor ring starting from a head pointer 201. Guest device driver 116₁ may update tail pointer 202 after completing the write of descriptors related to the I/O operation. In an embodiment, head pointer 201 and tail pointer 202 may be stored in a head register and a tail register (not shown in Figures).

In an embodiment, the descriptor may comprise data, I/O operation type (read or write), guest memory address for VI 141₁ to read data from or write data to, status of the I/O operation status and possible other information needed for the I/O operation.

In an embodiment, if guest device driver 116₁ can not work in a mode compatible with VI 141₁ assigned to guest VM 103₁, for example, if VI 141₁ can not implement the I/O operation based upon the descriptors written by guest device driver 116₁ because of different bit formats and/or semantics that VI 141₁ and guest device driver 116₁ support, then VI driver 116 may generate a shadow ring (as shown in FIG. 2b) and translate the descriptors, head pointer and tail pointer complying with the architecture of guest VM 103₁ into shadow descriptors (S-descriptor), shadow-head pointer (S-head pointer) and shadow-tail pointer (S-tail pointer) complying with the architecture of VI 141₁, so that VI 141₁ can implement the I/O operations based on the shadow descriptors.

It will be appreciated that the embodiments shown in FIGS. 2a and 2b are provided for illustration, and other technologies may implemented other embodiments of the I/O information. For example, the I/O information may be written in other data structures than the ring structures of FIG. 2a and FIG. 2b, such as hash table, link table, etc. For another example, a single ring may be used for both of receiving and transmission, or separate rings may be used for receiving or transmission.

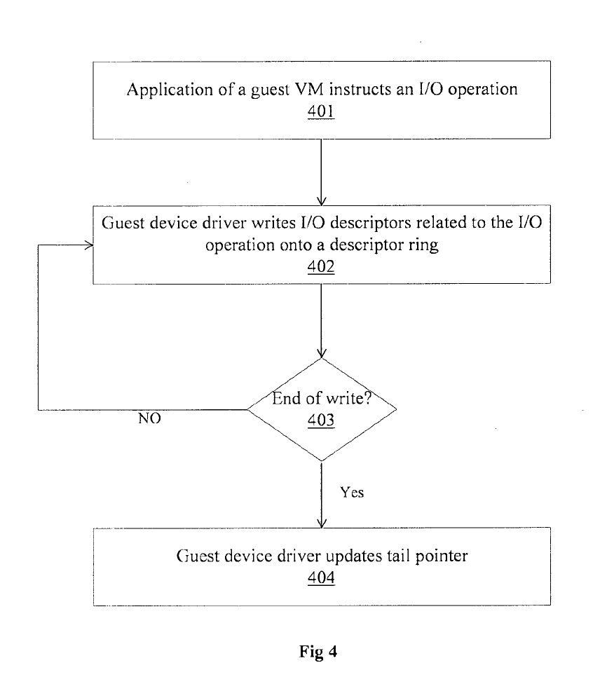

IOMMU or similar technology may allow I/O device 141 to direct access memory system 121 through remapping the guest address retrieved from the descriptors in the descriptor ring or the shadow descriptor ring to host address. FIG. 3 shows an embodiment of an IOMMU table. A guest virtual machine, such as guest VM 103₁, may have at least one IOMMU table indicating corresponding relationship between a guest memory address complying with architecture of the guest VM and a host memory address complying with architecture of the host computing system. VMM 102 and Service VM 103 may manage IOMMU tables for all of the guest virtual machines. Moreover, the IOMMU page table may be indexed with a variety of methods, such as indexed with device identifier (e.g., bus:device:function number in a PCIe system), guest VM number, or any other methods specified in IOMMU implementations.

It will be appreciated that different embodiments may use different technologies for the memory access. In an embodiment, IOMMU may not be used if the guest address is equal to the host address, for example, through a software solution. In another embodiment, the guest device driver may work with VMM 102 to translate the guest address into the host address by use of a mapping table similar to the IOMMU table.

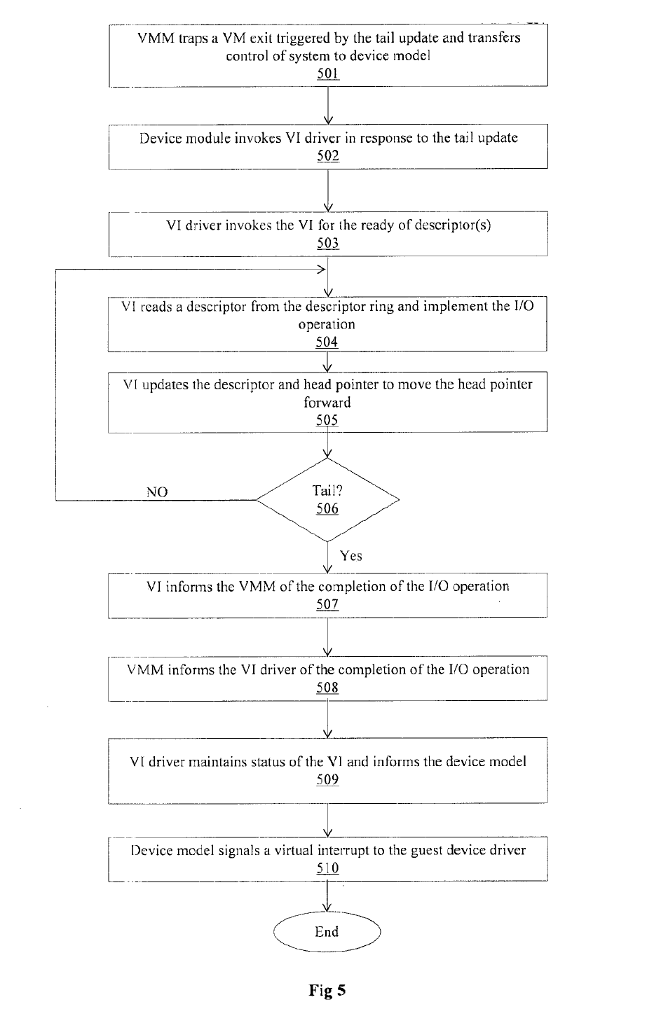

FIG. 4 shows an embodiment of a method of writing I/O information related to the I/O operation by a guest virtual machine. The following description is made by taking guest VM 103₁ as an example. It should be understood that the same or similar technology may be applicable to other guest VMs.

In block 401, application 117₁ running on guest VM 103₁ may instruct an I/O operation, for example, to write 100 packets to guest memory addresses xxx-yyy. In block 402, guest device driver 116₁ may generate and write I/O descriptors related to the I/O operation onto a descriptor ring of the guest VM 103₁, (e.g., the descriptor ring as shown in FIG. 2a or 2b), until all the descriptors related to the I/O operation is written into the descriptor ring in block 403. In an embodiment, guest device driver 116₁ may write the I/O descriptors starting from a head pointer (e.g., head pointer 201 in FIG. 2a or head pointer 2201 in FIG. 2b). In block 404, guest device driver 116₁ may update a tail pointer (e.g., tail pointer 202 in FIG. 2a or tail pointer 2202 in FIG. 2b) after all the descriptors related to the I/O operation have been written to the buffer.

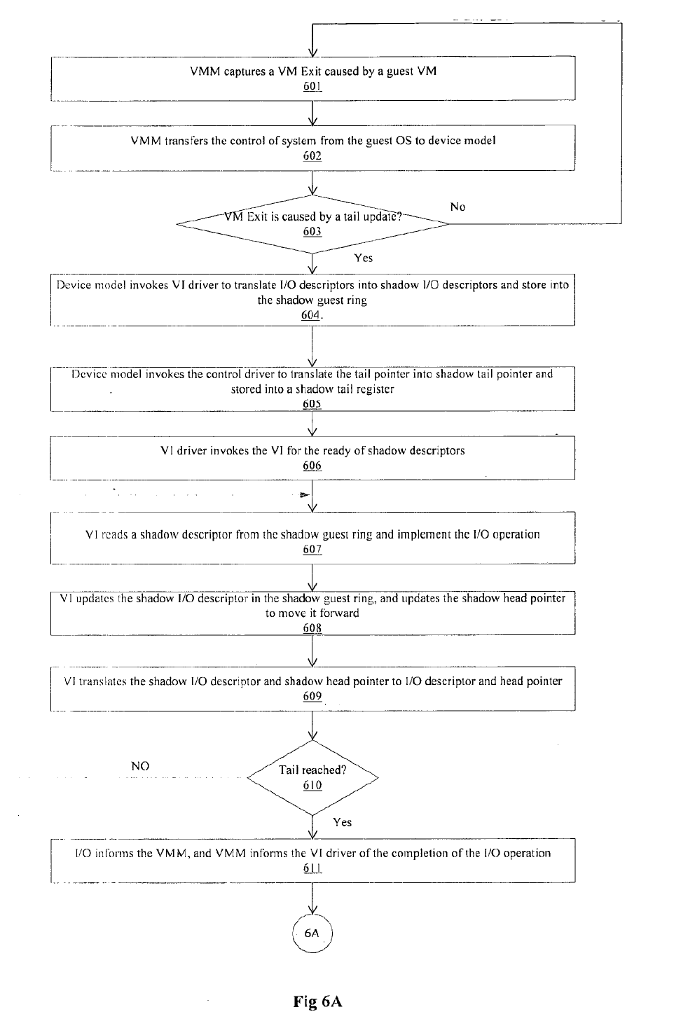

FIG. 5 shows an embodiment of a method of handling the I/O operation by service VM 103. The embodiment may be applied in a condition that a guest device driver of a guest virtual machine is able to work in a mode compatible with a VI and/or its driver assigned to the guest virtual machine. For example, the guest device driver is a legacy driver of 82571EB based NIC, while the VI is 82571EB based NIC or other type of NIC compatible with 82571EB based NIC, e.g., a virtual function of 82576EB based NIC. The following description is made by taking guest VM 103₁ as an example. It should be understood that the same or similar technology may be applicable to other guest VMs.

In block 501, that guest VM 103₁ updates the tail pointer (e.g., tail pointer 202 of FIG. 2a) may trigger a virtual machine exit (e.g., VMExit) which may be captured by VMM 102, so that VMM 102 may transfer the control of the system from guest OS 113₁ of guest VM 103₁ to device model 114 of service VM 103.

In block 502, device model 114 may invoke VI driver 116 in response to the tail update. In blocks 503-506, VI driver 116 may control VI 114₁ assigned to guest VM 103₁ to implement the I/O operation based upon the I/O descriptors written by guest VM 103₁ (e.g., the I/O descriptors of FIG. 2a). Specifically, in block 503, VI driver 116 may invoke VI 114₁ for the ready of the I/O descriptors. In an embodiment, VI driver 116 may invoke VI 114₁ by updating a tail register (not shown in Figs.). In block 504, VI 114₁ may read a descriptor from the descriptor ring of guest VM 103₁ (e.g., the descriptor ring as shown in FIG. 2a) and implement the I/O operation as described in the I/O descriptor, for example, receiving a packet and writing the packet to the guest memory address xxx. In an embodiment, VI 114₁ may read the I/O descriptor pointed by the head pointer of the descriptor ring (e.g., head pointer 201 of FIG. 2a).

In an embodiment, VI 114₁ may utilize IOMMU or similar technology to implement direct memory access (DMA) for the I/O operation. For example, VI₁ 114₁ may obtain host memory address corresponding to the guest memory address from a IOMMU table generated for the guest VM 103₁, and directly read or write the packet from or to memory system 121. In another embodiment, VI 114₁ may implement the direct memory access without the IOMMU table if the guest address is equal to the host address under a fixed mapping between the guest address and the host address. In block 505, VI 114₁ may further update the I/O descriptor, e.g., status of the I/O operation included in the I/O descriptor, to indicate that the I/O descriptor has been implemented. In an embodiment, VI 114₁ may or may not utilize the IOMMU table for the I/O descriptor update. VI 114₁ may further update the head pointer to move the head pointer forward and point to a next I/O descriptor in the descriptor ring.

In block 506, VI 114₁ may determine whether it reaches the I/O descriptor pointed by the tail. In response to not reaching, VI 114₁ may continue read the I/O descriptor from the descriptor ring and implement I/O operation instructed by the I/O descriptor in blocks 504 and 505. In response to reaching, VI 114₁ may inform VMM 102 of the completion of the I/O operation in block 507, e.g., through signaling an interrupt to VMM 102. In block 508, VMM 102 may inform VI driver 106 of the completion of the I/O operations, e.g., through injecting the interrupt to service VM 103.

In block 509, VI driver 116 may maintain status of VI 114₁ and inform device model 114 of the completion of the I/O operation. In block 510, device model 14 may signal a virtual interrupt to guest VM 113₁ so that guest device driver 116₁ may handle the event and inform application 117₁ that the I/O operations are implemented. For example, guest device driver 116₁ may inform application 117₁ that the data is received and ready for use. In an embodiment, device model 14 may further update a head register (not shown in Figs.) to indicate that the control of the descriptor ring is transferred back to the guest device driver 116₁. It will be appreciated that informing the guest device driver 116₁ may take place in other ways which may be determined by device/driver policies, for example, the device/driver policy made in a case that the guest device driver disables the device interrupt.

It will be appreciated that the embodiment as described is provided for illustration and other technologies may implement other embodiments. For example, depending on different VMM mechanisms, VI 114₁ may inform the overlying machine of the completion of I/O operation in different ways. In an embodiment, VI 141₁ may inform directly to service VM 103 rather than via VMM 102. In another embodiment, VI 114₁ may inform the overlying machine when one or more, rather than all, of the I/O operations listed in the descriptor ring is completed, so that the guest application may be informed of the completion of a part of the I/O operations in time.

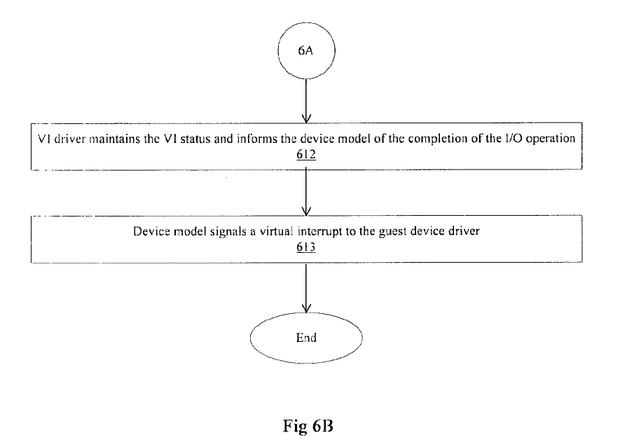

FIG. 6a-6b illustrate another embodiment of the method of handling the I/O operation by service VM 103. The embodiment may be applied in a condition that a guest device driver of a guest virtual machine is unable to work in a mode compatible with a VI and/or its driver assigned to the guest virtual machine. The following description is made by taking guest VM 103₁ as an example. It should be understood that the same or similar technology may be applicable to other guest VMs.

In block 601, VMM may capture a virtual machine exit (e.g., VMExit) caused by guest VM 103₁, e.g., when guest device driver 116 accessing a virtual device (e.g., device model 114). In block 602, VMM 102 may transfer the control of system from guest OS 113₁ of guest VM 103₁ to device model 114 of service VM 103. In block 603, device model 114 may determine if the virtual machine exit is triggered by a fact that guest device driver 116₁ has completed writing I/O descriptors related to the I/O operation to the descriptor ring (e.g., descriptor ring of FIG. 2b). In an embodiment, guest VM 113₁ may update a tail pointer (e.g., tail pointer 2202 of FIG. 2b) indicating end of the I/O descriptors. In that case, device model 114 may determine whether the virtual machine exit is triggered by the update of the tail pointer.

In response that the virtual machine exit is not triggered by the fact that guest device driver 116₁ has completed writing the I/O descriptors, the method of FIG. 6a-6b may go back to block 601, i.e., VMM may capture a next VM exit. In response that the virtual machine exit is triggered by the fact that guest device driver 116₁ has completed writing the I/O descriptors, in block 604, device model 114 may invoke VI driver 116 to translate the I/O descriptors complying with architecture of guest VM 103₁ into shadow I/O descriptors complying with architecture of VI 141₁ assigned to guest VM 103₁, and store the shadow I/O descriptors into a shadow descriptor ring (e.g., the shadow descriptor ring shown in FIG. 2b).

In block 605, VI driver 116 may translate the tail pointer complying with the architecture of guest VM 103₁ into a shadow tail pointer complying with the architecture of VI 141₁.

In blocks 606-610, VI driver 116 may control VI 114₁ to implement the I/O operation based upon the I/O descriptors written by guest VM 103₁. Specifically, in block 606, VI driver 116 may invoke VI 114₁ for the ready of the shadow descriptors. In an embodiment, VI driver 116 may invoke VI 114₁ by updating a shadow tail pointer (not shown in Figs.). In block 607, VI 114₁ may read a shadow I/O descriptor from the shadow descriptor ring and implement the I/O operation as described in the shadow I/O descriptor, for example, receiving a packet and writing the packet to a guest memory address xxx or reading a packet from the guest memory address xxx and transmitting the packet. In an embodiment, VI 114₁ may read the I/O descriptor pointed by a shadow head pointer of the shadow descriptor ring (e.g., shadow head pointer 2201 of FIG. 2b).

In an embodiment, VI 114₁ may utilize IOMMU or similar technology to realize direct memory access for the I/O operation. For example, VI₁ 114₁ may obtain host memory address corresponding to the guest memory address from an IOMMU table generated for the guest VM 103₁, and directly write the received packet to memory system 121. In another embodiment, VI 1141 may implement the direct memory access without the IOMMU table if the guest address is equal to the host address under a fixed mapping between the guest address and the host address. In block 608, VI 114₁ may further update the shadow I/O descriptor, e.g., status of the I/O operation included in the shadow I/O descriptor, to indicate that the I/O descriptor has been implemented. In an embodiment, VI 114₁ may utilize the IOMMU table for the I/O descriptor update. VI 114₁ may further update the shadow head pointer to move the shadow head pointer forward and point to a next shadow I/O descriptor in the shadow descriptor ring.

In block 609, VI driver 116 may translate the updated shadow I/O descriptor and shadow head pointer back to I/O descriptor and head pointer, and update the descriptor ring with the new I/O descriptor and head pointer. In block 610, VI 114₁ may determine whether it reaches the shadow I/O descriptor pointed by the shadow tail pointer. In response to not reaching, VI 114₁ may continue read the shadow I/O descriptor from the shadow descriptor ring and implement I/O operation described by the shadow I/O descriptor in blocks 607-609. In response to reaching, VI 114₁ may inform VMM 102 of the completion of the I/O operation in block 611, e.g., through signaling an interrupt to VMM 102. VMM 102 may then inform VI driver 106 of the completion of the I/O operation, e.g., through injecting the interrupt to service VM 103.

In block 612, VI driver 116 may maintain status of VI 114₁ and inform device model 114 of the completion of the I/O operation. In block 613, device model 114 may signal a virtual interrupt to guest device driver 116₁ so that guest device driver 116₁ may handle the event and inform application 117₁ that the I/O operation is implemented. For example, guest device driver 116₁ may inform application 117₁ that the data is received and ready for use. In an embodiment, device model 14 may further update a head register (not shown in Figs.) to indicate that the control of the descriptor ring is transferred back to guest device driver 116₁. It will be appreciated that informing guest device driver 116₁ may take place in other ways which may be determined by device/driver policies, for example, the device/driver policy made in a case that the guest device driver disables the device interrupt.

It will be appreciated that the embodiment as described is provided for illustration and other technologies may implement other embodiments. For example, depending on different VMM mechanisms, VI 114₁ may inform the overlying machine of the completion of I/O operation in different ways. In an embodiment, VI 141₁ may inform directly to service VM 103 rather than via VMM 102. In another embodiment, VI 114₁ may inform the overlying machine when one or more, rather than all, of the I/O operations listed in the descriptor ring is completed, so that the guest application may be informed of the completion of a part of the I/O operations in time.

While certain features of the invention have been described with reference to example embodiments, the description is not intended to be construed in a limiting sense.

Various modifications of the example embodiments, as well as other embodiments of the invention, which are apparent to persons skilled in the art to which the invention pertains are deemed to lie within the spirit and scope of the invention.

What is claimed is:

1. A method operated by a service virtual machine, comprising
invoking, by a device model of the service virtual machine, a device driver of the service virtual machine to control a part of an input/output (I/O) device to implement an I/O operation by use of I/O information, which is related to the I/O operation and is written by a guest virtual machine;
wherein the device model, the device driver, and the part of the I/O device are assigned to the guest virtual machine.

2. The method of claim 1, further comprising if the part of the I/O device can not work compatibly with architecture of the guest virtual machine, then:
translating, by the device driver, the I/O information complying with the architecture of the guest virtual machine into shadow I/O information complying with architecture of the part of I/O device; and
translating, by the device driver, updated shadow I/O information complying with the architecture of the part of I/O device into updated I/O information complying with the architecture of the guest virtual machine, wherein the updated I/O information was updated by the part of the I/O device in response to the implementation of the I/O operation.

3. The method of claim 1, further comprising:
maintaining, by the device driver, status of the part of the I/O device after the I/O operation is implemented.

4. The method of claim 1, further comprising;
informing, by the device model, the guest virtual machine that the I/O operation is implemented.

5. The method of claim 1, wherein the I/O information is written in a data structure starting from a head pointer that is controllable by the part of the I/O device.

6. The method of claim 1, wherein a tail pointer indicating end of I/O information is updated by the guest virtual machine.

7. An apparatus, comprising:
a device model and a device driver, wherein the device model invokes the device driver to control a part of an input/output (I/O) device to implement an I/O operation by use of I/O information which is related to the I/O operation and is written by a guest virtual machine, and wherein the device model, the device driver and the part of the I/O device are assigned to the guest virtual machine.

8. The apparatus of claim 7, wherein if the part of the I/O device can not work compatibly with architecture of the guest virtual machine, then the device driver:
translates the I/O information complying with the architecture of the guest virtual machine into shadow I/O information complying with architecture of the part of I/O device; and
translates updated shadow I/O information complying with the architecture of the part of I/O device into updated I/O information complying with the architecture of the guest virtual machine, wherein the updated I/O information was updated by the part of the I/O device in response to the implementation of the I/O operation.

9. The apparatus of claim 7, wherein the device driver further maintains status of the part of the I/O device after the I/O operation is implemented

10. The apparatus of claim 7, wherein the device model further informs the guest virtual machine that the I/O operation is implemented.

11. The apparatus of claim 7, wherein the I/O information is written in a data structure starting from a head pointer that is controllable by the part of the I/O device.

12. The apparatus of claim 7, wherein a tail pointer indicating end of I/O information is updated by the guest virtual machine.

13. A machine-readable medium, comprising a plurality of instructions which when executed result in a system:
invoking, by a device model of a service virtual machine, a device driver of the service virtual machine to control a part of an input/output (I/O) device to implement an I/O operation by use of I/O information, which is related to the I/O operation and is written by a guest virtual machine,
wherein the device model, the device driver and the part of the I/O device are assigned to the guest virtual machine.

14. The machine-readable medium of claim 13, wherein if the part of the I/O device can not work compatibly with architecture of the guest virtual machine, then the plurality of instructions further result in the system:
translating, by the device driver, the I/O information complying with the architecture of the guest virtual machine into shadow I/O information complying with architecture of the part of I/O device; and
translating, by the device driver, updated shadow I/O information complying with the architecture of the part of I/O device into updated I/O information complying with the architecture of the guest virtual machine, wherein the updated I/O information was updated by the part of the I/O device in response to the implementation of the I/O operation.

15. The machine-readable medium of claim 13, wherein the plurality of instructions further result in the system:
maintaining, by the device driver, status of the part of the I/O device after the I/O operation is implemented.

16. The machine-readable medium of claim 13, wherein the plurality of instructions further result in the system:
informing, by the device model, the guest virtual machine that the I/O operation is implemented

17. The machine-readable medium of claim 13, wherein the I/O information is written in a data structure starting from a head pointer that is controllable by the part of the I/O device.

18. The machine-readable medium of claim 13, wherein a tail pointer indicating end of I/O information is updated by the guest virtual machine.

19. A system, comprising:
a hardware machine comprising an input/output (I/O) device; and
a virtual machine monitor to interface the hardware machine and a plurality of virtual machines, wherein the virtual machine comprises:
a guest virtual machine to write input/output (I/O) information related to an I/O operation; and
a service virtual machine comprising a device model and a device driver, wherein the device model invokes the device driver to control a part of the I/O device to implement the I/O operation by use of the I/O information, and wherein the device model, the device driver and the part of the I/O device are assigned to the guest virtual machine.

20. The system of claim 19, wherein if the part of the I/O device can not work compatibly with architecture of the guest virtual machine, then the device driver of the service virtual machine further:
translates the I/O information complying with the architecture of the guest virtual machine into shadow I/O information complying with architecture of the part of I/O device; and
translates updated shadow I/O information complying with the architecture of the at least part of I/O device into updated I/O information complying with the architecture of the guest virtual machine, wherein the updated I/O information was updated by the part of the I/O device in response to the implementation of the I/O operation.

21. The system of claim 20, wherein the guest virtual machine writes the I/O information into a data structure starting from a head pointer which is updated by the part of the I/O device.

22. The system of claim 20, wherein the guest virtual machine updates a tail pointer indicating end of the I/O information.

23. The system of claim 20, wherein the virtual machine monitor transfers control of the system from the guest virtual machine to the service virtual machine, if detecting that the tail pointer is updated.

24. The system of claim 20, wherein the part of I/O device updates the I/O information in response that the I/O operation is implemented.

25. The system of claim 20, wherein the device driver maintains status of the part of the I/O device after the I/O operation is implemented.

26. The system of claim 20, wherein the device model informs the guest virtual machine that the I/O operation is implemented.
